(19) United States
(12) Patent Application Publication
(10) Pub. No.: US 2026/0200051 A1
(43) Pub. Date: Jul. 16, 2026

(54) DRYWALL SCREW GUN

(71) Applicant: MILWAUKEE ELECTRIC TOOL CORPORATION, Brookfield, WI (US)

(72) Inventors: Alex D. Servais, Slinger, WI (US); Rene Guerra, Milwaukee, WI (US); Grayson Adams, Lisbon, WI (US); Letian Ying, Bayside, WI (US)

(21) Appl. No.: 19/444,890

(22) Filed: Jan. 9, 2026

Related U.S. Application Data
(60) Provisional application No. 63/743,991, filed on Jan. 10, 2025.

(51) Int. Cl. B25B 21/02; B25B 23/00

(52) U.S. Cl. CPC B25B 21/02; B25B 23/0007

(57) ABSTRACT

A screw gun includes a housing, a motor assembly supported in the housing, a drive assembly configured to receive a rotational output from the motor assembly. The drive assembly includes an input shaft and an output shaft coupled to the input shaft for rotation with the input shaft. The output shaft is translatable along the input shaft from a depressed position to an extended position. A spring engages the output shaft to apply a biasing force to the output shaft to bias the output shaft to the extended position. The screw gun also includes a switching assembly including a link coupled to the output shaft, a rocker engageable by the link and including an activation element, the rocker pivotable between a first position and a second position, and a sensor configured to generate an output signal dependent on a position of the activation element.

### CROSS-REFERENCE TO RELATED APPLICATIONS

This application claims priority to U.S. Provisional Application No. 63/743,991, filed on January 10, 2025, the entire content of which is incorporated herein by reference.

### FIELD

The present disclosure relates to a drywall screw gun, and more particularly to a drive assembly of a drywall screw gun.

### BACKGROUND

Drywall screw guns often include a clutch system to transmit a rotational output from a motor to a bit holder and bit that engages a drywall screw to drive the drywall screw into a drywall substrate and framing stud. The clutch system is engaged when the drywall screw contacts the drywall substrate to transmit the rotational output of the motor. As the drywall screw driving operation is completed, the clutch assembly disengages and rotation of the motor ceases to be transmitted to the drywall screw. In this manner, the motor can continue to rotate without the rotation being transmitted to the bit holder and bit. Continuous rotation of the motor continuously draws power from the battery pack or other power source, which may result in draining the power from the battery pack more quickly.

### SUMMARY

The present disclosure provides, in one aspect, a screw gun configured to drive a fastener including: a housing; a motor assembly supported in the housing; a drive assembly configured to receive a rotational output from the motor assembly including an input shaft, an output shaft coupled to the input shaft for rotation with the input shaft, the output shaft translatable along the input shaft from a depressed position to an extended position, and a spring engaging the output shaft to apply a biasing force to the output shaft to bias the output shaft to the extended position; and a switching assembly including a link coupled to the output shaft, a rocker engageable by the link and including an activation element, the rocker pivotable between a first position and a second position, and a sensor configured to generate an output signal dependent on a position of the activation element.

The present disclosure provides, in another aspect, a screw gun configured to drive a fastener including: a housing supporting a trigger that is depressible from a released state to a depressed state; a motor assembly supported in the housing, the motor assembly configured to be activated by depression of the trigger; a drive assembly configured to receive a rotational output from the motor assembly including a shaft configured to receive a rotational output from the motor assembly, the shaft translatable relative to the housing between a depressed position and an extended position, and a spring engaging the shaft to apply a biasing force to the shaft to bias the shaft to the extended position; a switching assembly including a link coupled to the shaft, a rocker engageable by the link and including an activation element, the rocker is movable between a first position and a second position, and a sensor configured to generate an output signal dependent on a position of the activation element relative to the sensor; and an electronic control unit configured to receive the output signal and control operation of the motor assembly based on the position of the activation element.

The present disclosure provides, in another aspect, a screw gun configured to drive a fastener including: a housing supporting a trigger that is depressible from a released state to a depressed state; a motor assembly supported in the housing, the motor assembly configured to be activated by depression of the trigger; a drive assembly configured to receive a rotational output from the motor assembly including an input shaft, an output shaft coupled to the input shaft for rotation with the input shaft, the output shaft translatable along the input shaft from a depressed position to an extended position, and a spring engaging the output shaft to apply a biasing force to the output shaft to bias the output shaft to the extended position; a switching assembly including a link coupled to the output shaft, a rocker engageable by the link and including an activation element, the rocker movable between a first position and a second position, and a sensor configured to generate an output signal dependent on a position of the activation element; and an electronic control unit supported in the housing and configured to receive the output signal and control operation of the motor assembly based on a position of the activation element regardless of a position of the trigger.

Other features and aspects of the subject matter will become apparent by consideration of the following detailed description and accompanying drawings.

### BRIEF DESCRIPTION OF THE DRAWINGS

FIG. 1 is a schematic view illustrating a screw gun.

FIG. 2 is a cross-sectional view of a drive assembly of the screw gun of FIG. 1.

FIG. 3 is a cross-sectional view of a drive assembly of the screw gun of FIG. 1.

FIG. 4 is a cross-sectional view of an embodiment of an input shaft, output shaft, and rotational coupling.

FIG. 5 is a cross-sectional view of an embodiment of an input shaft, output shaft, and rotational coupling.

Before any embodiments of the subject matter are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

### DETAILED DESCRIPTION

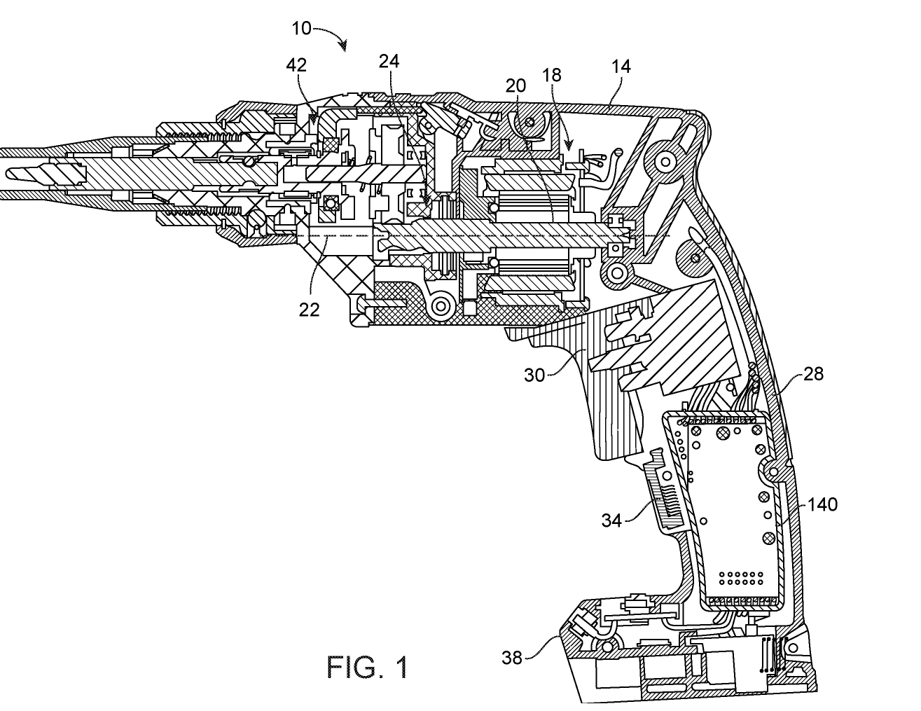

FIG. 1 schematically illustrates a screw gun 10 (e.g., a drywall screw gun) including a housing 14 that supports a motor assembly 18. The motor assembly 18 may be a brushless DC motor or other type of motor (e.g., a brushed motor or an AC motor). The motor assembly 18 includes a motor shaft 20 that defines a motor axis 22 about which the motor shaft 20 is rotatable. The screw gun 10 may also include a gear assembly 24 rotationally coupled to the motor assembly 18. In the illustrated embodiment, the gear assembly 24 includes a helical gear formed integrally with or coupled to the motor shaft 20 of the motor shaft 20. The gear assembly 24 may be any gear assembly configuration (e.g., a planetary gear assembly) and may have multiple stages and may be shiftable between different output gear ratios. The housing 14 includes a handle 28 including a trigger 30 that is operable to activate the screw gun 10, e.g., by depressing the trigger 30 from a released state (FIG. 1), to a depressed state. A mode selector 34 (e.g., a push-to-start button) is also supported by the handle 28 (e.g., below the trigger 30) and can be actuated to select between different operation modes (e.g., normal operation, in the unactuated state, a push-to-start mode in the actuated state). The mode selector 34 may be a depressible switch, a slidable switch, or other type of switch. A battery pack (not shown) may be removably couplable to the housing 14 (e.g., to a distal end 38 of the handle 28) to provide a power source for the motor assembly 18. In the present embodiment, the screw gun 10 may be operable in a normal operating mode and a push-to-start operating mode. In the normal operating mode, the motor assembly 18 is activated by depression of the trigger 30. In the push-to-start operating mode, the push-to-start operating mode is activated by depression of the mode selector 34. The motor assembly 18 is selectively activated for sequential fastening operations, as will be described in further detail below, by engaging and depressing a fastener against the drywall substrate, without requiring the user to operate the trigger 30 for each successive fastening operation.

The screw gun 10 includes a drive assembly 42 that rotates a fastener to drive the fastener into a drywall substrate and framing stud and a switching assembly 44 configured to activate and deactivate the motor assembly 18 to begin a fastener driving operation without the user having to operate the trigger 30 for each fastener driving operation.

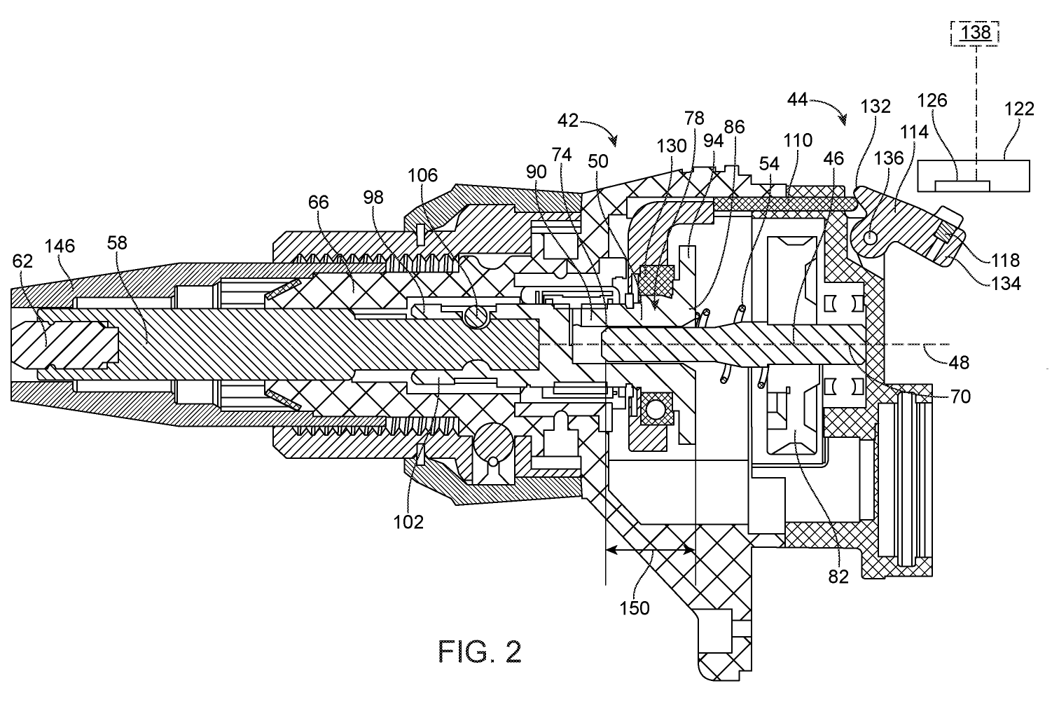

FIG. 2 illustrates a drive assembly 42 including an input shaft 46 defining a rotational axis 48, an output shaft 50, and a spring 54. A bit holder 58 may be removably couplable to the output shaft 50 and a bit 62 may be removably coupled to the bit holder 58. In other embodiments, the bit holder 58 and bit 62 may be integrally formed as a single component that is removably couplable to the output shaft 50. The bit 62 engages the fastener to drive the fastener into the drywall substrate and framing stud. The drive assembly 42 is at least partially supported within a drive assembly housing 66. The drive assembly housing may be integrally formed with (i.e., as a portion of the housing 14) or separated formed from and coupled to the housing 14. The input shaft 46 and output shaft 50 are rotatably supported in the drive assembly housing 66 and the output shaft 50, bit holder 58, and bit 62 are slidably supported within the drive assembly housing 66.

The input shaft 46 is rotationally coupled to the motor assembly 18 via the gear assembly 24 at a first end 70. The first end 70 may be coupled to a gear or carrier of the gear assembly 24 or may be separately supported (e.g., by a bearing) and rotationally coupled (e.g., by meshed gearing) with the gear assembly 24 to receive a rotational output from the gear assembly 24. The second end 74 of the input shaft 46 includes a rotational coupling 78, as will be described in further detail below. A backing plate 82 may be coupled to the input shaft 46 between the first end 70 and the second end 74. The backing plate 82 is part of the gear assembly 24 and is formed as a helical gear that receives rotation from the motor shaft 20 of the motor assembly 18. In other embodiments, the backing plate 82 may be formed in another manner (e.g., as a different gear style) to receive rotation from the motor assembly 18 via the motor shaft 20.

The output shaft 50 includes a first end 86 flange portion 94 into which a bore 90 extends to receive the input shaft 46. A flange portion 94 may extend radially outward from the first end 86. The opposite second end 98 of the output shaft 50 includes a receiving bore 102 configured to removably receive the bit holder 58. The output shaft 50 may include detents 106 or other features to retain the bit holder 58 within the receiving bore 102. The spring 54 engages the output shaft 50 (e.g., at the flange portion 94) and the backing plate 82 coupled to the input shaft 46. The spring 54 applies a biasing force to the output shaft 50 (e.g., via the flange portion 94) to bias the output shaft 50 along the input shaft 46 and away from the backing plate 82.

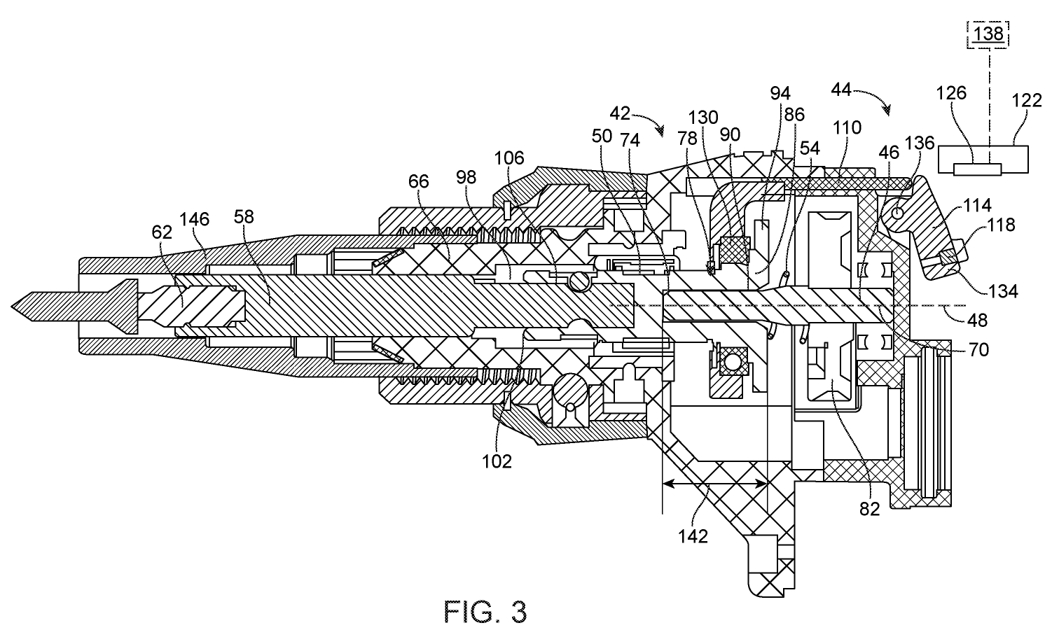

With continued reference to FIG. 2, the switching assembly 44 includes a link 110, a rocker 114 to which a magnet 118 is coupled, and a printed circuit board assembly 122 (“PCBA”) that includes a sensor 126. The link 110 is at least partially supported within the drive assembly housing 66. The link 110 is coupled to the output shaft 50 to translate with the output shaft 50. The link 110 is supported on the output shaft 50 by a bearing 130, permitting rotation of the output shaft 50 relative to the link 110. The link 110 is thereby translatable with, but does not rotate with, the output shaft 50. The rocker 114 is movable, e.g., pivotally coupled, adjacent to and is engageable by the link 110 at a proximal end 132 of the rocker 114. The magnet 118 is coupled to a distal end 134 of the rocker 114. A spring (e.g., a torsion spring) may be coupled to the rocker 114 to bias the rocker 114 to a first position (FIG. 3) and the link 110 engages the rocker 114 to overcome the force applied by the spring to pivot the rocker 114 about a pivot 136 to a second position (FIG. 2) in which the magnet 118 is positioned further from the sensor 126 than when the rocker 114 is in the first position. The PCBA 122 may be coupled to the housing 14, drive assembly housing 66, or another component of the screw gun 10. The sensor is a non-contact sensor (e.g., a Hall effect sensor, TMR sensor, etc.) that provides an output signal to an electronic control unit 138 (which may include a controller). In one embodiment, the electronic control unit 138 may be supported on the PCBA 122, or on another PCBA 140 (FIG. 1) supported in the screw gun (e.g., in the handle 28). In other embodiments, the magnet may instead be a metallic piece and the sensor may be another type of non-contact sensor such as inductive sensor. The output signal from the sensor 126 changes, or is dependent on, the position of the magnet 118 relative to the sensor 126. In the present embodiment, the sensor 126 provides an output signal to the electronic control unit 138 when the rocker 114 is in the first position and the magnet 118 is further from the sensor 126. The magnet and metallic piece are non-limiting examples of an activation element that causes the sensor 126 to generate a signal and/or modify the signal generated by sensor 126.

With reference to FIGS. 2 and 3, the screw gun 10 is configured to operate in a push-to-start mode in which the motor assembly 18 is activated by the electronic control unit 138 when an output signal is received from the sensor 126 indicating that the drive assembly 42 has been depressed via the engagement and depression of a fastener against a drywall substrate.

The output shaft 50 is slidable along the input shaft 46 between a depressed position (FIG. 3) and an extended position (FIG. 2). In the depressed position, the spring 54 is compressed and the input shaft 46 is disposed at a maximum depth 142 within the bore 90. The depressed position corresponds to the beginning of the fastener driving operation in which a fastener engaged by the bit 62 contacts the drywall substrate and the screw gun 10 is pressed against the drywall substrate to begin driving the fastener. By pressing the fastener against the drywall substrate, the pressing force applied by a user overcomes the bias applied by the spring 54 to the output shaft 50. As the output shaft 50 is translated along the input shaft 46 to the depressed position, the link 110 translates with the output shaft 50. The link 110 contacts the rocker 114 and pivots the rocker 114 about the pivot 136 to the first position, moving the magnet 118 to a distance from the sensor 126 that is larger than the distance between the magnet 118 and the sensor 126 when the rocker 114 is in the second position. The sensor 126 provides a signal to the electronic control unit 138 indicating the position of the magnet 118 and that the screw gun 10 is ready to fasten a fastener into the drywall substrate and framing stud. The electronic control unit 138 activates the motor assembly 18 in response to receiving the output signal from the sensor 126, regardless of the state of the trigger 30.

As the driving operation proceeds, rotation of the motor assembly 18 and gear assembly 24 rotate the input shaft 46, and, through the rotational coupling 78, the output shaft 50 about the rotational axis 48. The rotational axis 48 is therefore configured as an output axis. In the illustrated embodiment, the rotational axis 48 is offset from the motor axis 22 due to the arrangement of the gear assembly 24. In other embodiments, the screw gun 10 may be configured such that the motor axis 22 and the rotational axis 48 are aligned or coaxial. In other embodiments, the screw gun 10 may be configured such that the motor axis 22 and rotational axis 48 intersect in an angular arrangement. A cone 146 coupled to the drive assembly housing 66 contacts the drywall substrate as the screw gun 10 continues to be pressed toward the drywall substate by the user. The cone 146 contacts the drywall substrate when the fastener has been driven a depth that is less than the length of the fastener and provides a contact of the screw gun 10 against the drywall substrate. The fastener continues to be driven into the drywall substrate by rotation of the input shaft 46 and output shaft 50. Because the cone 146 provides a contact with the drywall substate, the force applied by the user is transferred through the cone 146 and is no longer acting to overcome the bias of the spring 54. The biasing force of the spring 54 is thereby applied to the output shaft 50 to translate the output shaft 50 along the input shaft 46 from the depressed position to the extended position. In some embodiments, the cone 146 is a component in an attachment assembly couplable to the screw gun 10. In other embodiments, the screw gun may include a magazine configured to store a fastener collation containing a plurality of fasteners disposed in a collating strip and the fasteners are sequentially fastened in the drywall substrate and framing stud.

As the output shaft 50 translates along the input shaft 46 from the depressed position, the link 110 translates with the output shaft 50. Translation of the link 110 away from the rocker 114 allows the rocker 114 to pivot back toward the second position and the magnet 118 moves closer to the sensor 126. In the extended position, the input shaft 46 is positioned at a minimum depth 150 within the bore 90 of the output shaft 50 at the completion of the fastening operation (i.e., when the fastener is fully seated in the drywall substrate). The sensor 126 provides an output signal to the electronic control unit 138 indicating that the rocker 114 is in the second position and the output shaft 50 is in the extended position. The electronic control unit 138 then disables the motor assembly 18.

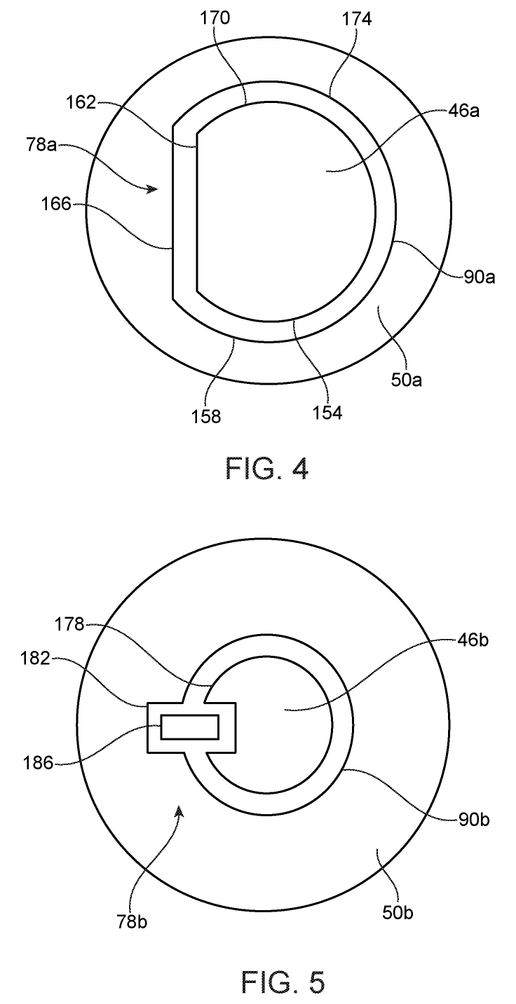

FIGS. 4 and 5 illustrate embodiments of rotational couplings. The rotational coupling 78 joins the input shaft 46 and output shaft 50 for co-rotation about the rotational axis 48. The rotational coupling may be any type of coupling that rotationally joins the input shaft 46 and output shaft 50.

In a first embodiment of a rotational coupling 78a shown in FIG. 4, the rotational coupling 78a is a D rotational coupling. The input shaft 46a and output shaft 50a each have a D-shaped cross-sectional profile 154, 158 (an exterior cross-sectional profile for the input shaft 46a, an interior cross-sectional profile of the bore 90a of the output shaft 50a). The cross-sectional profile 154, 158 each define a flat portion 162, 166 and an arcuate portion 170, 174, i.e., each cross-sectional profile 154, 158 is D-shaped. The first cross-sectional profile 154 of the input shaft 46a is positioned concentrically within the second cross-sectional profile 158 of the output shaft 50a. The flat portions 162, 166 correspond to lock rotation of the input shaft 46 and output shaft 50. In other embodiments, the rotational coupling may be a double-D rotational coupling, in which the input shaft 46a and output shaft 50a each have a cross-sectional profile having two flat portions and arcuate portions connecting the two flat portions.

In a second embodiment of a rotational coupling 78b, shown in FIG. 5, the rotational coupling 78b is a keyed coupling. The input shaft 46b and output shaft 50b each have keyways 178, 182 extending into the input shaft 46b (i.e., the outer diameter) and output shaft 50b (i.e., the inner diameter of the bore 90b. A key 186 is at least partially disposed in each keyway 178, 182, locking the input shaft 46b and output shaft 50b for co-rotation.

In another embodiment (not shown), the rotational coupling 78 may be a spline coupling (e.g., meshed teeth extending from the input shaft 46 receiving in and meshing with gear teeth extending from the output shaft 50). Other embodiments of rotational couplings may be used instead.

Although the subject matter has been described in detail with reference to certain preferred embodiments, variations and modifications exist within the scope and spirit of one or more independent aspects of the subject matter as described.

Various features of the subject matter are set forth in the following claims.

What is claimed is:

1. A screw gun configured to drive a fastener comprising:
a housing;
a motor assembly supported in the housing;
a drive assembly configured to receive a rotational output from the motor assembly including
an input shaft,
an output shaft coupled to the input shaft for rotation with the input shaft, the output shaft translatable along the input shaft from a depressed position to an extended position, and
a spring engaging the output shaft to apply a biasing force to the output shaft to bias the output shaft to the extended position; and
a switching assembly including
a link coupled to the output shaft,
a rocker engageable by the link and including an activation element, the rocker pivotable between a first position and a second position, and
a sensor configured to generate an output signal dependent on a position of the activation element.

2. The screw gun of claim 1, wherein the output shaft and the input shaft are coupled for rotation by a rotational coupling.

3. The screw gun of claim 2, wherein the rotational coupling is a splined shaft coupling.

4. The screw gun of claim 2, wherein the rotational coupling includes a key at least partially disposed in a first keyway of the input shaft and at least partially disposed in a second keyway of the output shaft.

5. The screw gun of claim 2, wherein the rotational coupling includes a D coupling defined by a first profile of the input shaft positioned concentrically within a second profile of the output shaft, the first profile and the second profile each having a D-shaped cross-section.

6. The screw gun of claim 2, wherein the sensor is a Hall effect sensor and the activation element is a magnet.

7. The screw gun of claim 1, wherein a motor axis defined by the motor assembly is offset from an output axis defined by the output shaft.

8. The screw gun of claim 1 further comprising a controller configured to receive the output signal and activate the motor assembly when the output signal indicates that the output shaft is in the depressed position.

9. A screw gun configured to drive a fastener comprising:
a housing supporting a trigger that is depressible from a released state to a depressed state;
a motor assembly supported in the housing, the motor assembly configured to be activated by depression of the trigger;
a drive assembly configured to receive a rotational output from the motor assembly including
a shaft configured to receive a rotational output from the motor assembly, the shaft translatable relative to the housing between a depressed position and an extended position, and
a spring engaging the shaft to apply a biasing force to the shaft to bias the shaft to the extended position;
a switching assembly including
a link coupled to the shaft,
a rocker engageable by the link and including an activation element, the rocker is movable between a first position and a second position, and
a sensor configured to generate an output signal dependent on a position of the activation element relative to the sensor; and
an electronic control unit configured to receive the output signal and control operation of the motor assembly based on the position of the activation element.

10. The screw gun of claim 9, wherein the link is coupled to the shaft by a bearing configured to permit rotation of the shaft relative to the link.

11. The screw gun of claim 9, wherein the rocker is pivotally coupled to the housing to rotate relative thereto.

12. The screw gun of claim 9, wherein the sensor is a Hall effect sensor and the activation element is a magnet.

13. The screw gun of claim 9, wherein a motor axis defined by the motor assembly is offset from an output axis defined by the shaft.

14. The screw gun of claim 9, wherein the shaft is an output shaft, the screw gun further comprising an input shaft, the output shaft coupled to the input shaft for rotation with the input shaft, the output shaft translatable along the input shaft.

15. The screw gun of claim 14, wherein the output shaft and the input shaft are coupled for rotation by a rotational coupling.

16. The screw gun of claim 15, wherein the rotational coupling is one of a splined shaft coupling, a key at least partially disposed in a first keyway of the input shaft and at least partially disposed in a second keyway of the output shaft, and a D coupling defined by a first profile of the input shaft positioned concentrically within a second profile of the output shaft, the first profile and the second profile each having a D-shaped cross-section.

17. The screw gun of claim 15, further comprising a backing plate coupled to the input shaft for rotation therewith, the spring engaging the backing plate and the output shaft.

18. The screw gun of claim 9, wherein the electronic control unit is configured to control the motor assembly regardless of a state of the trigger.

19. The screw gun of claim 9, wherein the electronic control unit activates the motor assembly when the output signal indicates that the shaft is in the depressed position.

20. A screw gun configured to drive a fastener comprising:
a housing supporting a trigger that is depressible from a released state to a depressed state;
a motor assembly supported in the housing, the motor assembly configured to be activated by depression of the trigger;
a drive assembly configured to receive a rotational output from the motor assembly including
an input shaft,
an output shaft coupled to the input shaft for rotation with the input shaft, the output shaft translatable along the input shaft from a depressed position to an extended position, and
a spring engaging the output shaft to apply a biasing force to the output shaft to bias the output shaft to the extended position;
a switching assembly including
a link coupled to the output shaft,
a rocker engageable by the link and including an activation element, the rocker movable between a first position and a second position, and
a sensor configured to generate an output signal dependent on a position of the activation element; and
an electronic control unit supported in the housing and configured to receive the output signal and control operation of the motor assembly based on a position of the activation element regardless of a position of the trigger.
